(19) United States
(12) Patent Application Publication
(10) Pub. No.: US 2006/0291922 A1
(43) Pub. Date: Dec. 28, 2006

(54) Fusing unit and image forming apparatus using the same

(75) Inventors: Dong-jin Seol, Suwon-si (KR); Jae-hyeuk Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/375,058

(22) Filed: Mar. 15, 2006

(30) Foreign Application Priority Data
Jun. 23, 2005 (KR) 10-2005-0054384

(51) Int. Cl. G03G 15/20

(52) U.S. Cl. 399/329

(57) ABSTRACT

A fusing apparatus and an image forming apparatus using the fusing apparatus are provided. The fusing apparatus includes a fusing roller having a heat generating unit and a pressing unit having a fusing belt and at least two pressing members supporting the fusing belt to rotate and contact the fusing roller.

### CROSS-REFERENCE TO RELATED PATENT APPLICATION

This application claims the benefit of Korean Patent Application No. 10-2005-0054384, filed on Jun. 23, 2005, in the Korean Intellectual Property Office, the disclosure of which is hereby incorporated by reference in its entirety.

### BACKGROUND OF THE INVENTION

1. Field of the Invention

The present invention relates to an image forming apparatus. More particularly, the invention relates to an image forming apparatus having a fusing unit using a fusing belt to fuse an image on a paper.

2. Description of Related Art

In general, an image forming apparatus is an apparatus for forming a desired image by receiving digital image signals corresponding to the desired image, forming an electrostatic latent image on a photosensitive medium using an exposing unit such as a laser scanning unit (LSU), developing a toner image from the electrostatic latent image using a toner, transferring the toner image to a recoding medium, and fusing the toner image on the recording medium by applying heat and pressure to the toner image.

A single-pass type color image forming apparatus generally includes four photosensitive drums, four exposing units forming the electrostatic latent images on four photosensitive drums, and four developing units. Each developing unit performs the development by supplying toners having black K, cyan C, magenta M, and yellow Y colors to the electrostatic latent images formed on the four photosensitive drums. The four photosensitive drums contact an intermediate transfer belt. The K, C, M, and Y toner images developed on the four photosensitive drums are overlapped and transferred to the intermediate transfer belt to form a color toner image. The color toner image is transferred and fused onto a paper, so that a color image is printed.

FIG. 1 is a longitudinal cross sectional view showing a two-roller type fusing apparatus using a fusing roller and a pressing roller.

Referring to FIG. 1, a fusing unit includes a fusing roller 10 constructed with a cylindrical shaped metal pipe and a pressing roller 20 disposed to face the fusing roller 10 through a paper 30 under the fusing roller 10.

A heat generating unit 12 constructed with a halogen lamp is disposed at a center of an inner portion of the fusing roller 10. A release layer 13 made of Teflon™ or the like is formed on the outer surface of the fusing roller 10. The heat generating unit 12 generates heat in the inner portion of the fusing roller 10. The fusing roller 10 receives radiation energy transmitted from the heat generating unit 12 and is heated by thermal energy converted by an opto-thermal conversion layer provided on an inner surface layer thereof. Thermal conduction of the thermal energy transmitted to the fusing roller 10, enables the release layer 13 to heat up to a predetermined temperature.

The pressing roller 20 includes a metal pipe 21 provided to rotate about a shaft 23, an elastic rubber layer 22 provided on a circumferential surface of the metal pipe 21, and a spring unit 24 pressing the shaft 23 toward the fusing roller 10.

A nip N defines a contact area in which the fusing rollers 10 and the pressing roller 20 contact each other. The paper 30 passing through the nip between the fusing roller 10 and the pressing roller 20 is pressed with a biasing force by the spring unit 24.

At this time, a toner image 31 in a powder form that is formed on the paper 30 is pressed and heated with heat and pressure applied by the pressing roller 20 and the fusing roller 10.

The toner image 31 is fused on the paper 14 with heat and pressure by the fusing roller 10 and the pressing roller 20.

Since the conventional fusing apparatus using the halogen lamp as a heat source consumes a large amount of unnecessary electric power, there is a need to lower the temperature by blocking power when there is no printing task. When turned on for the printing task, the conventional fusing apparatus requires a relatively long warm-up time until the apparatus reaches a fusing temperature.

Since the fusing roller of the conventional fusing apparatus is heated by the radiation energy transmitted from the heat source, the heat transmission rate is slow. Since the heat is transmitted to the paper by the contact of the fusing roller to the paper and it is difficult to compensate quickly for changes in temperature, it is difficult to control the temperature distribution of the fusing roller.

Recently, the printing speed of the image forming apparatus has been high, and a time of the paper passing through the fusing unit has been shortened. However, since a nip width defined by the a contact area between the fusing roller and the pressing roller is narrow, there are limitations in forming an image at high speeds. Therefore, the nip must be enlarged in order to shorten the time of the paper passing through the fusing unit and facilitate high speed printing.

Methods of enlarging the nip include increasing the diameter of the fusing roller or the pressing roller, increasing the thickness of a release layer or an elastic rubber layer formed on an outmost circumferential surface of each roller, and increasing the nip pressing force.

In the first method, there is a shortcoming in that, since the diameters of rollers increases, the whole volume increases and warm-up is slow.

In the second method, warm-up is slow, and the temperature of the fusing roller needs to be raised in order to maintain the temperature of the outmost layer such as the release layer and the elastic rubber layer at a fusing temperature. Therefore, there is a problem of high-temperature deterioration and lower durability of an adhesive portion, the release layer, or the elastic rubber layer of the fusing roller.

In the third method, although a fusing characteristic can be ensured by improving a pressing characteristic of the pressing roller, if the pressure to the nip increases, durability may deteriorate due to severe deformation of the release layer or the elastic rubber layer, jams may easily occur due to deterioration in a paper feeding characteristic, and the apparatus may be overstrained due to increase in a driving torque.

### SUMMARY OF THE INVENTION

The present invention provides a fusing apparatus having a pressing unit using a fusing belt in order to increase a nip area between a fusing roller and the pressing unit of an image forming apparatus. The invention is also directed to an image forming apparatus using the fusing apparatus.

According to an aspect of the present invention, there is provided a fusing apparatus comprising: a fusing roller having a heat generating unit; and a pressing unit having a fusing belt and at least two pressing members supporting the fusing belt to circulate and contact the fusing roller.

These and other aspects and salient features of the invention will become apparent from the following detailed description of the invention which disclose embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a longitudinal cross sectional view showing a conventional two-roller type fusing apparatus using a fusing roller and a pressing roller;

FIG. 2 is a side view schematically showing a construction of a single-pass type color image forming apparatus using a fusing apparatus according to an embodiment of the present invention;

FIG. 3 is a longitudinal cross sectional view showing a construction of a fusing apparatus according to an embodiment of the present invention shown in FIG. 2;

FIG. 4 is a partial perspective view showing a supporting member shown in FIG. 3;

FIG. 5 is a perspective view showing supporting rollers according to another embodiment of the present invention; and

FIG. 6 is a longitudinal cross sectional view showing a construction of a fusing apparatus according to a second embodiment of the present invention.

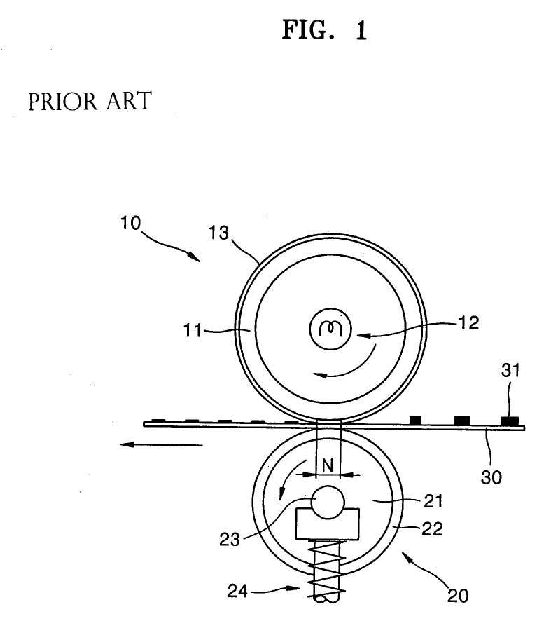

### DETAILED DESCRIPTION OF THE INVENTION

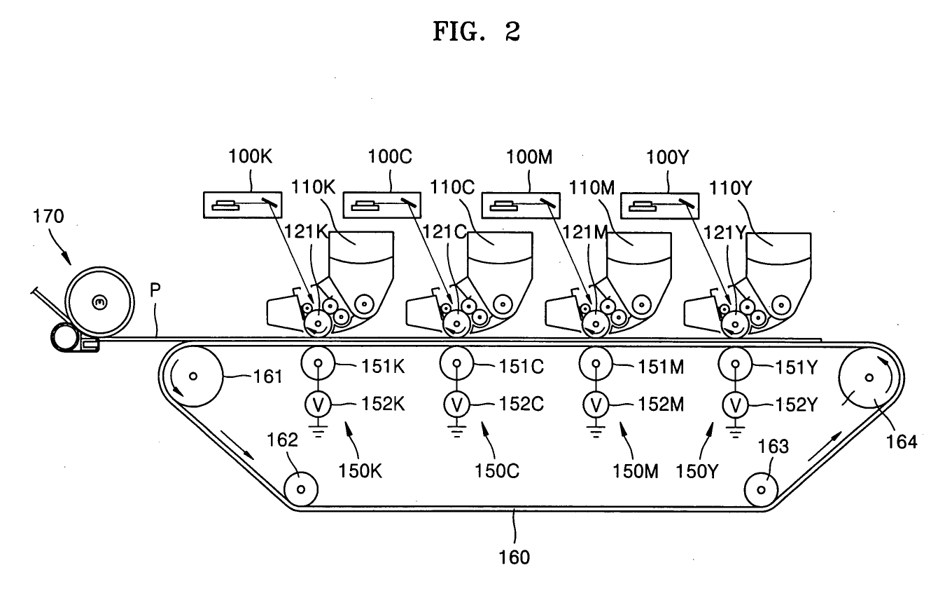

Referring to FIG. 2, a color image forming apparatus includes four exposing units 100K, 100C, 100M, and 100Y, four developing units 130K, 130C, 130M, and 130Y having respective photosensitive drums 121K, 121C, 121M, and 121Y, four transfer units 150K, 150C, 150M, and 150Y, a feeding belt 160, and a fusing apparatus 170.

The exposing units 100K, 100C, 100M, and 100Y form electrostatic latent images by irradiating light of black K, cyan C, magenta M, and yellow Y colors corresponding to image information on the photosensitive drums 121.

The developing units 130K, 130C, 130M, and 130Y perform development by supplying toners having black K, cyan C, magenta M, and yellow Y colors to the electrostatic latent images on the photosensitive drums 121.

The feeding belt 160 faces the photosensitive drums 121K, 121C, 121M, and 121Y and feeds a paper P through the developing units. The photosensitive drums 121K, 121C, 121M, and 121Y contact a paper P or the feeding belt 160. The paper P adheres to the feeding belt 160 with an electrostatic force.

The transfer units 150K, 150C, 150M, and 150Y include transfer rollers 151K, 151C, 151M, and 151Y facing the photosensitive drums 121K, 121C, 121M, and 121Y. Voltage applying members 152K, 152C, 152M, and 152Y are provided for applying voltages to the transfer rollers 151K, 151C, 151M, and 151Y.

If the voltage applying members 152K, 152C, 152M, and 152Y apply transfer voltages having polarities opposite to the toner images to the transfer rollers 151K, 151C, 151M, and 151Y, transfer electric fields are applied to a rear surface of the feeding belt 160. K, C, M, and Y color toner images formed on the photosensitive drums 121K, 121C, 121M, and 121Y are overlapped and transferred to a paper P, so that a color toner image is formed on a paper P.

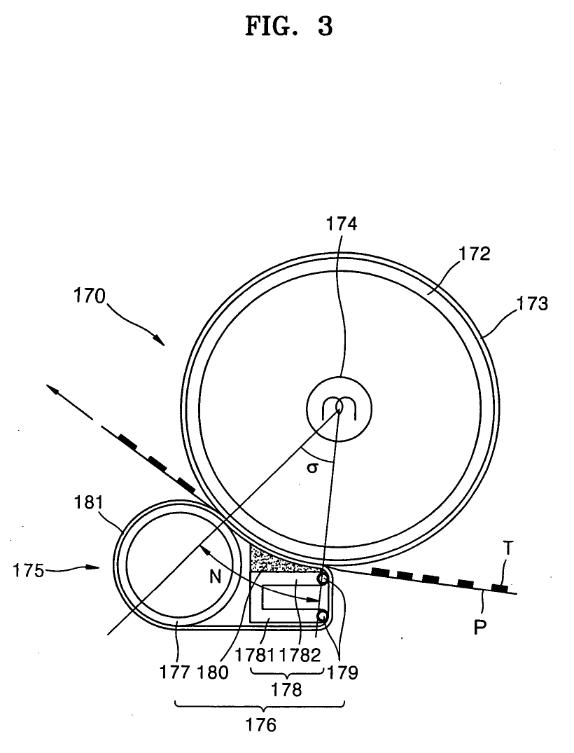

As shown in FIG. 3, the fusing unit 170 for fusing the color toner image T on the paper by applying heat and pressure includes a fusing roller 171 and a pressing unit 175.

The fusing roller 171 applies heat to the color toner image T and includes a pipe-shaped cylindrical metal core pipe 172 and a heat generating unit 174 for generating heat using current transmitted from an external power supply (not shown) and directing the heat to an inner side of the metal core pipe 172. A release layer 173 made of an elastic material is provided on a circumferential surface of the metal core pipe 172 to improve releasability of the toner image.

Radiation energy (heat) generated by the heat generating unit 174 is transmitted to the metal core pipe 172 through the air charged in an inner portion of the metal core pipe 172 and is converted to thermal energy by an opto-thermal conversion layer (not shown) coated on an inner side surface of the metal core pipe 172 to heat the fusing roller 174. The release layer 173 is heated up to a predetermined fusing temperature by thermal conduction through the core 172.

The pressing unit 175 presses the paper P on which the toner image T is transferred toward the fusing roller 171 with a predetermined pressure. The pressing unit 175 includes a pressing member 176 and a fusing belt 181.

The pressing member 176 supports an inner side of the fusing belt 181 to rotate the belt and includes a pressing roller 177 and a supporting member 178.

The pressing roller 177 having the shape of a cylinder with a predetermined diameter rotatably supports one portion of the fusing belt 181 and presses the fusing belt 181 into contact with the fusing roller 171.

The supporting member 178 rotatably supports the other portion of the fusing belt 181 and includes first and second supporting members 1781 and 1782. Supporting rollers 179 are rotatably supported by the ends of the first and second supporting members 1781 and 1782 and contact the rotating fusing belt 181 to support the fusing belt 181.

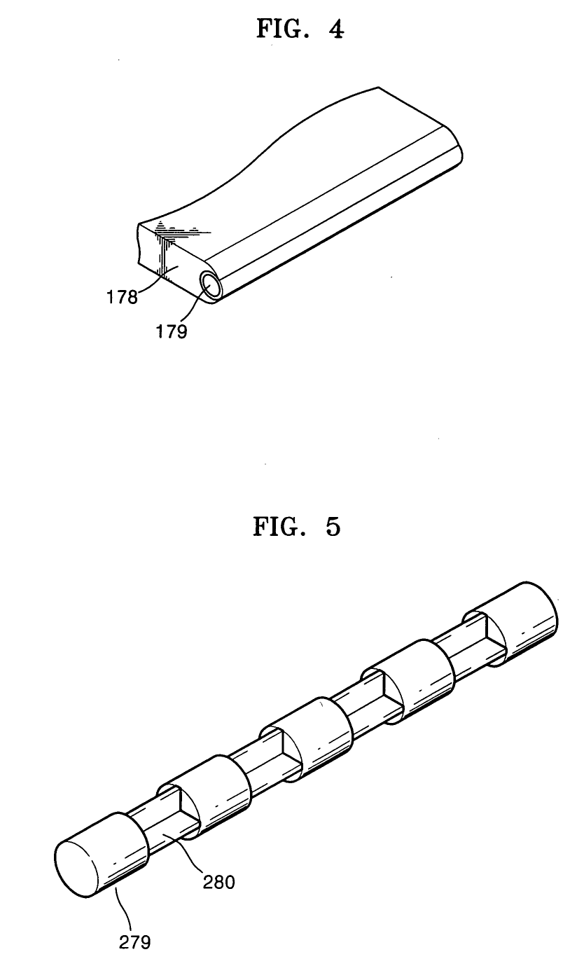

As shown in FIG. 4, the supporting rollers 179 have a shape of a cylinder with a continuous cylindrical surface. Referring to FIG. 5, a supporting roller 279 according to another embodiment includes a plurality of cross-shape ribs 280 to provide cylindrical sections in a predetermined interval. The end portions of the cross-shape ribs 280 are rounded in the shape of an archto contact and support the fusing belt 181. The supporting rollers 279 with the cross-shape ribs 280 have the advantage of reducing the contact area with the fusing belt 181.

Other structures in addition to the cross-shape ribs may be employed to reduce the contact area of the roller with the fusing belt.

The supporting member 178 is provided with a first elastic member 180 supporting the fusing belt 181 to circulate and press the fusing belt 181 toward the fusing roller 171 at a location opposite the fusing roller 171. Preferably, the first elastic member 180 is formed with a shape matching an outer shape of the fusing roller 171 to maintain a pressing force between the fusing belt 181 and the fusing roller 171.

A first resilient member 180 is formed so that a thickness thereof increases along a proceeding direction of the paper P.

The pressing roller 177 and the supporting member 178 are separated from each other a predetermined distance. A nip angle σ is formed at the axis of the fusing roller 171 at the contact points between the pressing roller 177 and the supporting roller 179. The size of the nip N formed by the contact of the belt 181 between the fusing belt 181 and the fusing roller 171 is determined by the space between the pressing roller 177 and the supporting member 178 as determined by the nip angle σ.

In other words, a smaller nip angle σ decreases the nip N, and a larger nip angle σ increases the nip N. Therefore, preferably the pressing roller 177 and the supporting member 178 are disposed on an inner side of the fusing belt 181 in order to support the fusing belt 181 to rotate and to maximize the size of the nip N where the fusing belt 181 contacts the fusing roller 171.

The fusing belt 181 may be constructed by forming a base layer, a release layer on a base layer, an elastic layer on a base layer, or a release layer on the elastic layer. The base layer may be made of a polymer material such as polyimide (PI) or a metal material such as nickel (Ni), a Ni alloy, stainless steel, aluminum (Al), an alloy thereof, copper (Cu), and a Cu alloy.

The first resilient member 180 may be made of an silicone rubber, urethane, a foamed resin, or the like. The release layer may be made of a fluorine containing resin such as PTFE.

The pressing roller 177 may be driven the a separate driving power source. The fusing belt 181 may also rotate by the separate driving power source. The fusing belt 181 may passively rotate by contacting the fusing roller 171.

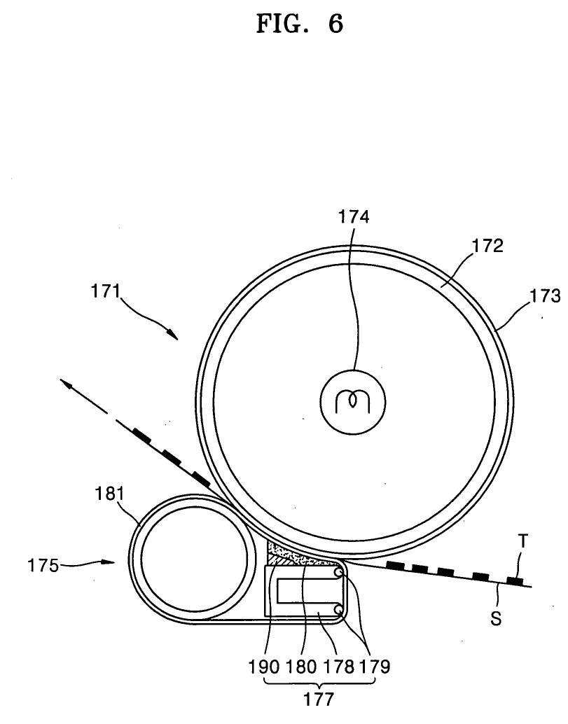

Referring to FIG. 6, the construction of a fusing apparatus according to a second embodiment of the present invention is the same as the fusing apparatus according to the embodiment shown in FIG. 3 except for the first elastic member 180. Therefore, like members having like functions are denote by the same reference numerals, and description thereof is omitted.

The first resilient member 180 according to the embodiment shown in FIG. 3, has a thickness that increases along the proceeding direction of the paper P, although the elastic coefficients of thick and thin portions of the first resilient member 180 are the same. Therefore, a larger amount of elastic or resilient deformation is formed in the thick portion than in the thin portion.

Since the elastic deformation of the first resilient member 180 varies along the proceeding direction of the paper P, the pressures exerted on the fusing belt 181 toward the fusing roller 171 are different in different areas. More specifically, the pressure exerted on the fusing belt 181 toward the fusing roller 171 is lower at the portion having large elastic deformation than at the portion having small elastic deformation.

Therefore, in order to equalize the elastic deformation of the first resilient member 180, a second resilient member 190 having an elastic coefficient different from that of the first elastic member 180 is provided to the middle thicker portion. Preferably, the elastic coefficient of the second resilient member 190 is greater than that of the first resilient member 180. The resilient member 180 of the embodiments of FIGS. 3 and 6 are preferably positioned for continuous contact of the fusing belt 181 against the fusing roller 171 along the length of the first resilient member 180.

The second elastic member 190 is disposed between the first elastic member 180 and the supporting member 178. In this manner, the first elastic member 180 has a more uniform thickness compared to the embodiment of FIG. 3.

Although examples where the fusing apparatus 170 according to the present invention are applied to the single-pass type color image forming apparatus are described above, the image forming apparatus is not limited to the single pass type. The fusing apparatus 170 can be applied to all the electrophotography scheme image forming apparatuses.

According to a fusing apparatus of the present invention, the following effects can be obtained.

First, a nip width is enlarged using a fusing belt, so that it is possible to increase a nip retention time of a paper on which a toner image is transferred corresponding to a printing speed.

Second, a nip pressing force can be reduced, so that it is possible to increase the life of the parts.

While several embodiments are described herein, it will be understood that various changes and modifications can be made without departing from the scope of the invention as defined in the appended claims.

What is claimed is:

1. A fusing apparatus comprising:
a fusing roller having a heat generating unit; and
a pressing unit having a fusing belt and at least two pressing members supporting and rotating the fusing belt in contact with the fusing roller.

2. The fusing apparatus of claim 1, wherein the pressing member comprises:
a pressing roller having a predetermined diameter and supporting a first portion of the fusing belt; and
a supporting unit having a plurality of supporting members supporting a second portion of the fusing belt to rotate the fusing belt around the pressing roller and the supporting members.

3. The fusing apparatus of claim 2,
wherein the supporting unit comprises first and second supporting members which are separated from each other by a predetermined distance, and
wherein ends of the first and second supporting members include supporting rollers.

4. The fusing apparatus of claim 3, wherein the supporting rollers are provided with a plurality cross-shaped ribs to reduce contact areas with the fusing belt.

5. The fusing apparatus of claim 3,
wherein the supporting unit further comprises a first resilient member which supports the fusing belt to resiliently contact the fusing roller, and
wherein the first resilient member has a thickness that increases along a proceeding direction of a paper being fed through the fusing apparatus.

6. The fusing apparatus of claim 5, wherein the first resilient member is supported by one of the first and second supporting members.

7. The fusing apparatus of claim 5, wherein the supporting unit further comprises a second resilient member having an elastic coefficient which is different from that of the first resilient member so as to maintain a uniform contact force between the fusing roller and the fusing belt supported by the first resilient member along the proceeding direction of the paper.

8. The fusing apparatus of claim 7, wherein the second resilient member is supported by one of the first and second supporting members.

9. The fusing apparatus of claim 7, wherein the elastic coefficient of the second resilient member is greater than that of the first resilient member.

10. An image forming apparatus having developing units with a plurality of photosensitive medium on which different color toner images are formed, a feeding belt facing the plurality of the photosensitive medium to transport and support a paper on which the different color toner images are to be transferred, and a fusing unit fusing the toner images onto the paper, wherein the fusing unit comprises:
a fusing roller having a heat generating unit; and
a pressing unit having a fusing belt and at least two pressing members supporting and rotating the fusing belt in contact with the fusing roller.

11. The image forming apparatus of claim 10, the pressing member comprises:
a pressing roller having a predetermined diameter and supporting a first portion of the fusing belt; and
a supporting unit having a plurality of supporting members supporting a second portion of the fusing belt to rotate the fusing belt around the pressing roller and the supporting members.

12. The image forming apparatus of claim 11,
wherein the supporting unit comprises first and second supporting members which are separated from each other by a predetermined distance, and wherein supporting rollers are provided to ends of the first and second supporting members include supporting rollers.

13. The image forming apparatus of claim 12, wherein the supporting rollers are provided with a plurality cross-shaped ribs to reduce contact areas with the fusing belt.

14. The image forming apparatus of claim 12,
wherein the supporting unit further comprises a first resilient member which supports the fusing belt to resiliently contact the fusing roller, and
wherein the first resilient member has a thickness that increases along a proceeding direction of a paper being fed through the fusing apparatus.

15. The image forming apparatus of claim 14, wherein the first resilient member is supported by one of the first and second supporting members.

16. The image forming apparatus of claim 14, wherein the supporting unit further comprises a second resilient member having an elastic coefficient which is different from that of the first resilient member so as to maintain a uniform contact force between the fusing roller and the fusing belt supported by the first resilient member along the proceeding direction of the paper.

17. The image forming apparatus of claim 16, wherein the second resilient member is supported by one of the first and second supporting members.

18. The image forming apparatus of claim 16, wherein the elastic coefficient of the second resilient member is larger than that of the first resilient member.
